(19) United States
(12) Patent Application Publication
(10) Pub. No.: US 2019/0210051 A1
(43) Pub. Date: Jul. 11, 2019

(54) SHOWER HEAD WITH SENSOR

(71) Applicant: JORDAN SYBRANDT, SAN DIEGO, CA (US)

(72) Inventor: JORDAN SYBRANDT, SAN DIEGO, CA (US)

(21) Appl. No.: 15/868,100

(22) Filed: Jan. 11, 2018

(51) Int. Cl. B05B 12/00; B05B 1/18; E03C 1/04

(52) U.S. Cl. CPC B05B 12/008; E03C 1/0408; B05B 1/18

(57) ABSTRACT

A filter system that includes: a shower head; a filtration system integrated within the shower head; and a set of water flow nozzles on the shower head. The filter system also includes a sensor, where said sensor measures water flow through the shower head. The sensor includes an alerting mechanism related to water flow, where said alerting mechanism is a light.

### BACKGROUND OF THE INVENTION

### Field of Invention

The present invention relates to a shower head that has an integrated sensor to detect water flow.

### Description of Related Art

Shower heads are a common bathroom appliance. Shower heads are installed in various configurations, shapes and sizes. However, showers provide a convenient means to clean and wash as opposed to drawing a bath. Normally, a significant amount of water is used while taking a shower, as a result it's important to monitor the water usage in certain instances. Some shower heads have been installed with filters to filter certain aspects of the water prior to release through the water nozzles. The use of filters in shower heads and other household appliances require maintenance. This maintenance usually involves the changing of the filter after a certain period of use. The water flow must be monitored in order to determine the timing of a filter change. It is the object of the present invention to provide a sensor installed within a shower head to alert the user of a filter life after a certain level of usage.

### SUMMARY OF THE INVENTION

The present invention relates to a filter system that includes: a shower head; a filtration system integrated within the shower head; and a set of water flow nozzles on the shower head. The filter system also includes a sensor, where said sensor measures water flow through the shower head. The sensor includes an alerting mechanism related to water flow, where said alerting mechanism is a light.

### BRIEF DESCRIPTION OF DRAWINGS

FIG. 1 depicts the shower head in accordance with the present invention.

### DETAILED DESCRIPTION

The present invention relates to a shower head that includes an internal sensor that monitors water flow through the shower head. The sensor alerts the user of the water flow that passed through the shower head and filter and therefore determines the effectiveness of the filter within the shower head. Preferably, the sensor includes a lighting system that depicts a series of lights that indicate the effectiveness of the filter within the shower head. This lighting system may be depicted in the traditional green, yellow or red sequence. Where the green depicts an active effective filter, yellow indicates a diminished filter and red depicts an ineffective filter and thus the need for replacement therein. Filter use within a shower head according to the present invention are effective based upon the number of gallons that have transferred through the shower head. Various types of filters may be constructed into the shower head based upon the longevity of use.

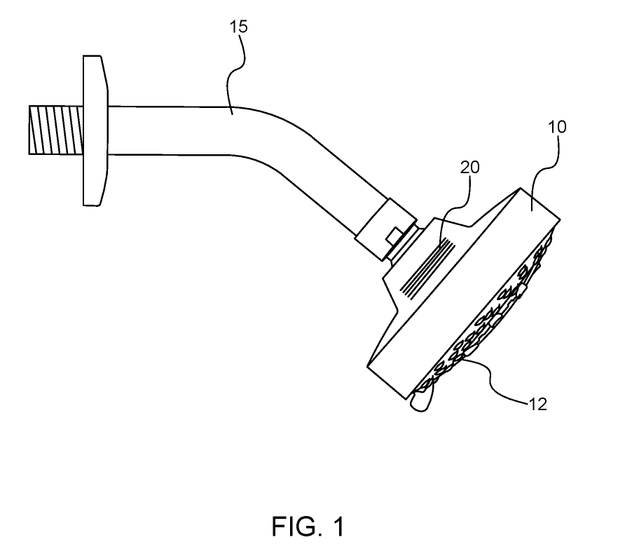

In reference to FIG. 1, a shower head 10 according to the present invention is depicted. The shower head 10 as shown includes a sensor 20 and a series of water flow nozzles 12. The water flow nozzle arrangement is not critical however various types of arrangements may be provided on the shower head 10. Sensor 20 monitors water flow through the shower head 10. A filter within the shower head 10 filters water prior to release through the water flow nozzles 12. The shower head 10 is attached to water pipe 15 in a conventional shower arrangement. The sensor 20 may include a lighting sequence, where a source of light is provided associated with the sensor where the water flow is determined by a measurement mechanism within the Sensor 20. The lighting sequence may be implemented with the present invention with a green light showing an active effective filter, a yellow light showing a diminished filter and then a red light showing an ineffective water filter for a need for a replacement thereof.

The sensor 20 may be also equipped with a Bluetooth signal to transfer data to a smart phone or tablet application connected thereto. This sensor 20 provides active data regarding water flow through the shower head 10. This data may be easily accessible through such an application and monitored by the user with real time data related to the filter within the shower head. Therefore the shower head is effectively filtered with the effective filter due to the functions related to the sensor.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A filter system comprising;
a. a shower head;
b. a filtration system integrated within the shower head; and
c. a set of water flow nozzles on the shower head.

2. The filter system according to claim 1, further including a sensor, where said sensor measures water flow through the shower head.

3. The filter system according to claim 1, where the sensor includes an alerting mechanism related to water flow.

4. The filter system according to claim 3, where said alerting mechanism is a light.
